(19) United States
(12) Patent Application Publication
(10) Pub. No.: US 2008/0249981 A1
(43) Pub. Date: Oct. 9, 2008

(54) SYSTEMS AND METHODS FOR FEDERATING DATA

(75) Inventors: Jan-Michael Norring, Sammamish, WA (US); Kalpana Narayanaswamy, Redmond, WA (US); David G. Bettin, Snoqualmie, WA (US)

Correspondence Address: BLACK LOWE & GRAHAM, PLLC, 701 FIFTH AVENUE, SUITE 4800, SEATTLE, WA, 98104, US

(73) Assignee: SynerG Software Corporation, Kirkland, WA (US)

(21) Appl. No.: 12/099,050

(22) Filed: Apr. 7, 2008

Related U.S. Application Data
(60) Provisional application No. 60/910,567, filed on Apr. 6, 2007.

(51) Int. Cl. G06F 7/00; G06F 17/30

(52) U.S. Cl. 707/2; 707/E17.005

(57) ABSTRACT

The system and method federates relational and non-relational data by business users creating a virtual relational map of unrelated data in disparate systems. The method uses a declarative language to capture data relationships. As the relationships are built, it captures a virtual relational data map of all the data existing in multiple disparate systems. This virtual map can be viewed as a relational database of enterprise data, further new relationships can be added and existing relationships can be modified. The method supports any business client (user interface or programmatic) that has knowledge of how to modify the virtual relationship map or request for federated data. The map of relationships itself can be constructed and modified by users as they are working with the system unlike traditional techniques where relationships need to be predefined and likewise, new changes and additions to the map are made available to users immediately in real-time.

### PRIORITY CLAIM

This application claims priority to U.S. Provisional Patent Application No. 60/910,567 filed on Apr. 6, 2007, the subject matter of which is incorporated herein by reference in its entirety.

### FIELD OF THE INVENTION

The present invention generally pertains to enterprise software technologies, more specifically to the field of data federation at the user level.

### BACKGROUND OF THE INVENTION

Over time programs are slowly moving away from a monolithic, tightly coupled, static approach to developing business applications. The monolithic approach made data, business logic, and a user interface all part of the same application stack typically causing each component to be dependent upon the other. Thus, even the smallest change triggered a full software development cycle: development, integration, testing, and deployment. While the monolithic approach provided a self-contained application with a greater level of control over behavior, the end-result was a static and rigid in the face of change. Once the software was developed using the monolithic approach it was deployed to users, the subsequent revisions were costly to the business both in terms of time and resources and the development cycle. In addition, the closed nature of the monolithic application often led to repeated functionality and a high cost of integration to fit it into the enterprise community.

Service Oriented Architecture (SOA) is a computer systems architectural style for creating and using a unit of logic, data and business processes, packaged as services, throughout their lifecycle. The adoption of SOA is one of the most significant initiatives taking place in the industry today. Application silos containing duplicated data and functionality which cater to a specific function of the business are now made available as business services that are reusable and standards-based across different business functions. However, as SOA has created reusable access to data and logic, the application silos still contain specific hardwired user interfaces do not effectively scale to the demands of modem business user's requirements and processes. Business applications require their user interfaces and business rules to be extensible as the requirements vary from one business function to another and from one end user to another. To be effective in this landscape, the application framework adopted should be able to quickly adapt to these variations from simple user specific interface layout changes to more complex department specific business logic variations. Further it also becomes desirable for a single framework to cater to the various device needs of the mobile business user—Desktops, SmartPhones, Tablet devices, or PDAs.

For many enterprises today, reacting quickly to rapidly changing business needs to gain a competitive edge is a high priority. It has become imperative for applications to quickly adapt to changes which are optimized for the business via process flows and customized interfaces. The recent phenomenon with Web 2.0 in the business marketplace indicates that a fundamental shift is taking place with users' increasing expectations and a shift towards empowering the business users to meet these changing expectations. More users have increased influence in driving their own experience and are bringing these same expectations to the business environment. Business users want business applications to adjust to the way they work, rather than accept a suboptimal experience. Composite solutions that bring together information and behavior, present today in application silos, is becoming increasingly important in the enterprise to deliver to the user needs and drive business efficiency. Further, it becomes essential to have a business application platform that provides a mechanism to build adaptive applications, eliminating hardwired and fragile dependences.

Currently there are three common technology solutions for data integration across data silos: (1) data movement tools such as Extract-Transform-Load (ETL), (2) data query and aggregation tools such as Enterprise Information Integration (EII) and (3) Enterprise Application Integration (EAI). ETL is a process in data warehousing that involves: extracting data in bulk from outside sources, transforming it to fit business needs (which can include quality levels), and ultimately loading the data into the end target, i.e. the data warehouse. EII is a process of information federation to create virtual data views, using data abstraction to provide a single programmatic interface for viewing a specific set of data within an organization, and a single set of structures and naming conventions to represent this data; the goal of EII is to get a large set of heterogeneous data sources to appear to a user or system as a single, homogeneous data source. EAI is a process of translating and transforming a set piece of data across a pre-defined process to copy existing data between two or more applications.

Currently, there are three main techniques used for integrating data: consolidation, integration and federation. Data warehousing (consolidation) captures data from multiple source systems and consolidates it into a single persistent data store. This stored data may be used for reporting and analysis, or it can act as a source of data for downstream applications. With data consolidation, there is usually a delay or latency, between the time updated data is received in the source system and the time the updated data arrives at the target location. Data integration applications copy and duplicate data from one location to another. Generally data integration systems use data intensive tasks such as transformation, translation, reconciling, cross-matching, de-duping, and cleansing of data. Data integration systems are destructive, and physically replace data in one system with data from another system. The result is multiple copies of data. They tend to be process centric and have a very high upfront and ongoing maintenance cost. Data federation provides a single virtual view of one or more source data sources. When a business application issues a query against this virtual view, a data federation engine retrieves data from the appropriate source data stores, integrates it to match the virtual view and query definition, and sends the results to the requesting business application. Data federation requires data to be mapped between various data stores before it can be shown to a user. By definition, data federation always pulls data from source systems on an on-demand basis. However, this technique requires prior definition of relationships of how the data in different data sources are related before a virtual view can be represented. Enterprise information integration (EII) is an example of a technology that supports a federated approach to data integration.

All of the above mentioned methods have required that the data be clean, pre-related, and prepared before it can be used by the business system. The process of getting the data into a consumable format for use is done prior to use of the data in the business application. It is often very costly and difficult to initially and continually relate and clean up data. The ongoing maintenance effort in keeping the data clean and mapped correctly is a laborious, time intensive and inefficient process in the enterprise today.

### SUMMARY OF THE INVENTION

System and methods for user driven data federation are disclosed herein. A system for data federation including a plurality of data sources, an information federator, a virtual data relationship map, a display and a processor. The information federator is configured to extract data and logic from the plurality of data sources. The virtual data relationship map is in data communication with the information federator such that when data is accessed in the plurality of data sources, the data can be linked across the multiple data sources. A display showing a user interface configured to allow a user to interact, change, map, re-map and perform clean-up with an abstracted set of data, and a processor configured to communicate any changes of the data or the virtual data relationship map to the information federator such that the underlying data is manipulated in the plurality of data sources based on the stored logic and the virtual data relationship map across the plurality of data sources is kept up to date in the system.

A method for data federation including capturing data relationships (metadata) in a plurality of disparate systems. A virtual relationship data map is a virtual data of the enterprise is comprised of all of the data relationships as needed by the business user of the data existing in the plurality of disparate systems. A user interface displays the data in a format meaningful to the user of enterprise data including all of the data from the plurality of disparate systems. A link between the data displayed in the plurality of disparate systems is modified by the user through the user interface; such that data mappings and clean up processes can be constructed and modified by users as they are working with the system in real-time. The virtual relationship map is updated to include the modified link, such that the link is now stored in the virtual relationship map for future use by the system.

### BRIEF DESCRIPTION OF THE DRAWINGS

The preferred and alternative embodiments of the present invention are described in detail below with reference to the following drawings:

FIG. 1 is a block diagram showing a computer, various computer peripherals, and various communication means for the computer according to an embodiment of the invention;

FIG. 2 is a schematic diagram showing an interactive business application ecosystem having an interface module in communication with two or more data stores or silos through a service oriented architecture system according to an embodiment of the invention;

FIG. 3 is a diagram showing data federation system that captures data relationships and federates data in real-time during usage according to an embodiment of the invention;

FIG. 4 shows a data federation overview in one embodiment; and

FIG. 5 shows a method for federating data in one embodiment.

### DETAILED DESCRIPTION OF THE PREFERRED EMBODIMENT

In the following description, certain specific details are set forth in order to provide a thorough understanding of various embodiments of the invention. In other instances, well-known structures and methods associated with software application, development, and software building techniques and systems, and methods of accessing data using business applications may not be shown or described in detail to avoid unnecessarily obscuring descriptions of the embodiments of the invention.

The invention provides data federation technology where business users can federate data in real-time while they are working with the data. For example, the system provides the capability to capture the knowledge of the data relationships as they are mentally constructed by the users while they are interacting with the data. Further, the relationships are captured in a non-destructive declarative form which can be easily changed. Thus, organizations may change and maintain their data relationships in response to the needs of their business in an agile and flexible manner.

As will be readily appreciated from the foregoing summary, the invention provides systems and methods for building and developing data federated software applications. In particular, the system and method federate unrelated pieces of information from multiple data sources in real-time as the user is working with the information. The design permits the user to create, change, recreate and delete relationships between data in multiple systems as the user is working with the data without physically altering the data itself. Further, since the data relationships can be defined and changed as the users work with the data, the technique provides a unique solution to solving data cleanliness issues in businesses by making the data more reliable with system usage. Moreover, the system and method provides for a mechanism to capture the mosaic of data analysis mentally constructed by the user while they are working with the data to enable it to be recreated in the future, or put to use to deliver a more efficient and self-learning system.

The following description generally relates to a system and method for dynamically federating data in real-time as defined by end-users of the system. The system and method federates relational and non-relational data by creating a virtual relational map of unrelated data in disparate systems. The method uses a declarative language to capture data relationships. As the relationships are built, it captures a virtual relational data map of all the data existing in multiple disparate systems. This virtual map can be viewed as one big relational database of enterprise data. New relationships can be added to this virtual map and existing relationships can be modified. The method is not restrictive to work within only a proprietary user interface (display) business application, but can support any business client (user interface or programmatic) that has knowledge of how to modify the virtual relationship map or request for federated data. The map of relationships itself can be constructed and modified by users as they are working with the system, unlike traditional techniques where relationships need to be predefined and likewise, new changes and additions to the map are also made available to the community of users immediately in realtime.

For many businesses today, empowering end-users of business applications to design and customize the business information presented to them on their interface, permits the end-users to react quickly to rapidly changing business needs, which may, in the aggregate, permit the business to gain a competitive edge over competitors. By way of example, businesses receive customer and vendor inquiries all the time. A customer may call to obtain billing information about a product they own. The customer may also have a few questions about the status of a product accessory recently ordered and may further have one or more technical questions regarding the operation or functionality of the product. These different systems may have conflicting data or it may be hard to link the customer across systems. Conventionally these systems would have to be worked with manually or a series of windows would have to open to the business user so that they could manually deduce relationships, if the windows were closed, then the relationships would be lost. In one embodiment, the present invention permits business users, for example the people receiving the customer or vendor inquiries, to actively work with the data stored across multiple data silos in multiple formats. The user is able to link data across multiple systems and make data changes that apply to each information silo. The system operates to store the links between the data sets in a virtual map and the changes are applied to the affected data source using the required logic.

For example, in the cellular telephone industry, a caller may have multiple lines, for multiple family members, a wireless card, and other services. The first time the account owner calls he/she would have to list all of their phone numbers and the relationships between the phone numbers. The call center operator would bring up all the data relating to each account, possibly accessing a billing screen, a phone usage screen, a plan screen etc. This could take time and be frustrating to the customer. Once all of that data is brought up in one session that data is linked for future use. These links are stored in a virtual data map and the next time the data is accessed the links will be available, allowing for a faster call the next time, a single place to change user data, and a method to audit the data to ensure no conflicts exist.

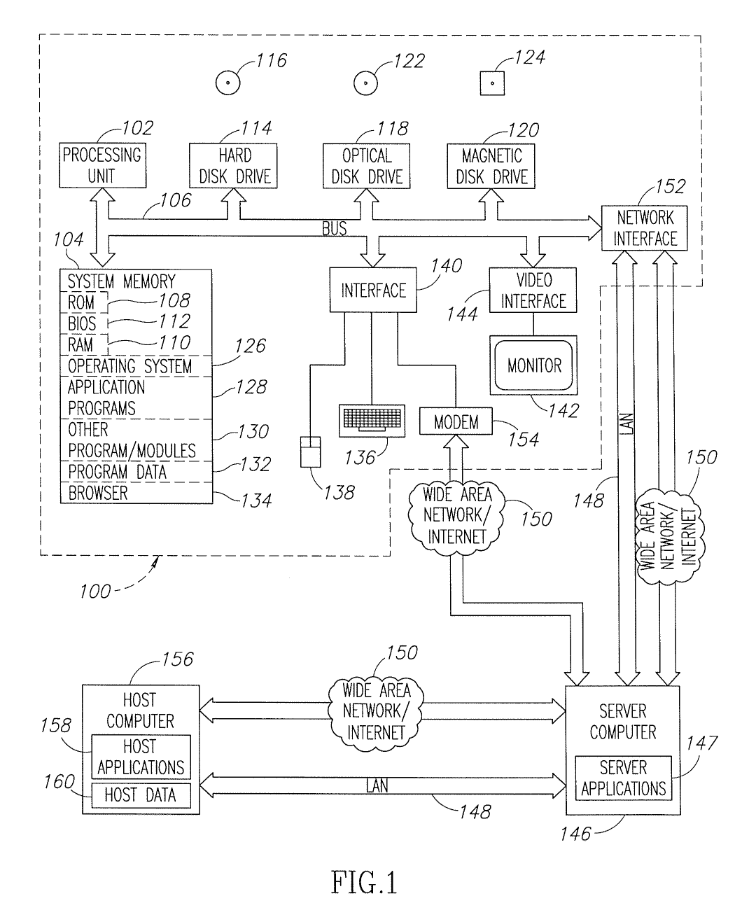

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

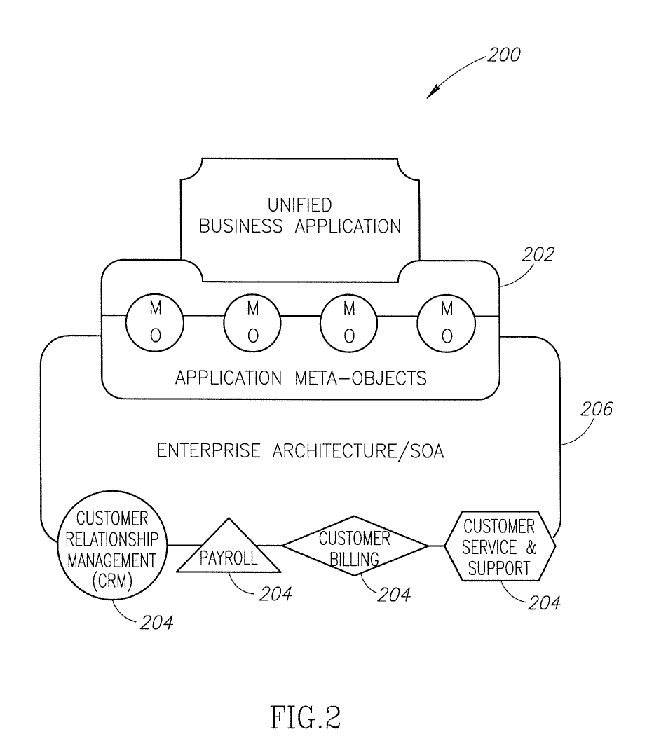

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The system memory 104 also includes a browser 134 for permitting the computer 100 to access and exchange data with sources such as web sites of the Internet, corporate intranets, or other networks as described below, as well as other server applications on server computers such as those further discussed below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 10 as a personal computer, in other embodiments, the computer is some other computer-related device such as a personal data assistant (PDA), a cell phone, or other mobile device.

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

FIG. 2 schematically shows an interactive business application ecosystem 200 having an interface module 202 in communication with two or more data stores or silos 204 through an enterprise architecture or service oriented architecture (SOA) system 206. The interactive business application ecosystem 200 permits an end-user of the application to manipulate the data from the silos 204 without being hardcoded to any particular silo. The end-user may then efficiently work with the data across multiple information silos. The end-user can further create virtual relationships and mapping of the data in different silos as they are working with the data as described in this invention. The data sources may be internal, external, or both, and may be integrated with other enterprise data.

The interface module 202 dynamically converts every data source into XML and then builds a model of the context of all the data elements, referred to herein as “federated data.” The end-user may obtain a view of exactly the data required from each data source without having to independently access each data source and without having to copy data using the virtual screen approach. Advantageously, the ecosystem 200 does not distinguish between run-time and design time so changes on how the data is presented to the end-user may be made in real time by the end-users themselves using menus with drag and drop capability that communicate with the interface module 202. The changes to the data and the links between the data are also stored in real time as a business user manipulates the data.

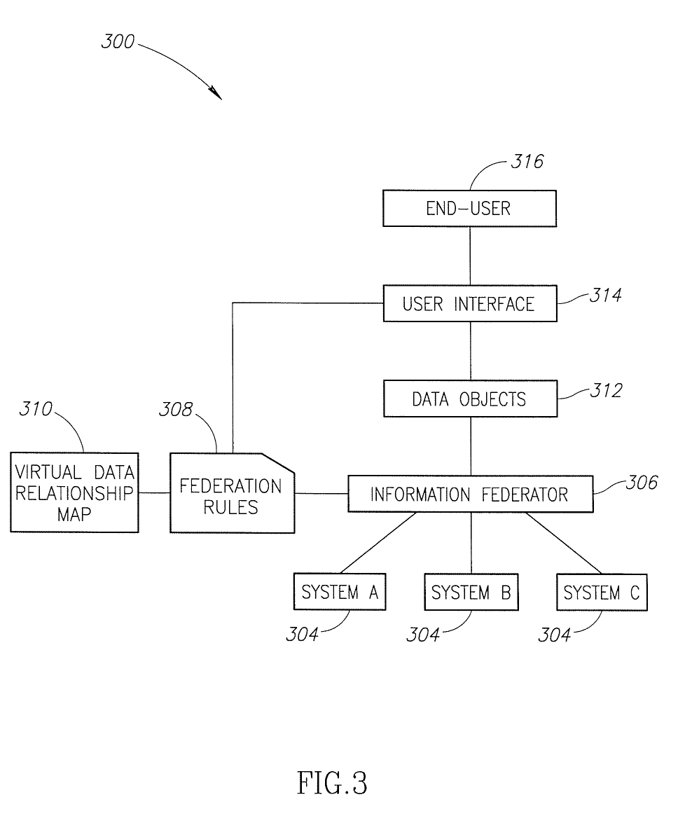

The interactive business application ecosystem 200 delivers scenarios at runtime while the user is working with the information. User federated record list—The user can bring in records from multiple systems as a single record set in the user interface module 202 for viewing and transacting purposes. The user can define a record list made up of a combination of records from multiple systems such as records taken from System A, System B, System C, etc. User federated record—The user can bring in a combination of fields that make up a single record from records taken or extracted from multiple systems. The single record is displayed on the user interface module 202 for viewing and transacting purposes. The user can define a record list made from a combination of fields, such as fields taken from System A, System B, System C. etc. User consolidated record list—The user can consolidate multiple records in a record set to be shown as a single entity for display and transacting purposes. The record set can contain multiple records, which are variations of the same entity. With this multiple records can be viewed as a single record display in the user interface module 202. User defined data relationships—The user can define new, meaningful relationships amongst data in multiple systems. By way of example, a record set in System A and a record set in System B are two disjoint record sets without any existing relational mapping of the data defined in either system. The user can create in the user interface module 202 a new relationship with primary key and/or foreign key associations to define a relationship between the two record sets. The user may use the new relationships to view information, navigate related information based on the new relationship, or create new business rules that cooperate with the formerly disjoint systems. Data cleanup—the user can find multiple instances of the same data. In one example, the user can correct erroneous records and remove those additional records. Duplications can occur in some instances when systems store account information based on email addresses or last names. When a user changes email addresses a new account is created, and they lose the history and data of the initial account. In this example the data can be cleaned up in real-time and the duplicate data removed using the user interface module 202. In another example, the same account can have different names in different data sources. The user interface can be setup to flag the user of such errors which the user can correct in real-time as they are viewing the information. Data enrichment. In many business situations, it becomes essential for the user or a business group to track pertinent information on-the-fly in a temporary or permanent manner. Information that is important for the business but is not tracked in plurality of data sources. In this scenario the user or business group working with the federated data from multiple sources can additionally track extra information pertinent to the federated information. In one example, the success of a special promotional program can be measured and tracked by the user without the need to rewire the back-end data sources. FIG. 3 shows a user interface system 300 having an information federator 302 that combines data and business logic from multiple data sources 304. The multiple data sources 304 may be internal, external or both and may be integrated with other enterprise data. The federation rules 308 are captured and constructed as a virtual relational map of the data across systems in the enterprise that can be modified not only during setup of the system, but advantageously by the end-user during execution of the system. The information federator 306 captures the data stored in a data source, as well as the logic necessary to interact with that data. This logic is based on how the data is stored, how the data is manipulated, and how the data is linked within the individual data source. The federation rules 308 are in data communication with the data virtual relationship map 310. The data virtual relationships map 310 stores a plurality of relationships between the data in multiple data sources and data records, and is abstracted to a higher level of the stack to enable data objects to work with the data as a whole, and not be hard coded to work only with the individual data sources. Generally, all of the data is mashed together out of all of the data sources; the data relationship map advantageously links related data together across all data sources in order to be accessed by data objects 312. A data object 312 communicates with the federation rules 308, to determine where and how to retrieve the data and how to combine various other rules and instructions. The user interface 314, is in communication with both data objects 312 as well as the federation rules 308. The user interacts with the data through the user interface 312. Instead of having separate data management employees, the system allows an end business user 316 to interact with and cleanup the data in the multiple data sources 304. If an end user 316 manipulates a record in a data source, the record is changed in the data source based on the federation rules through using the information federator to correctly manipulate the underlying data. The functionally of the system 300, allows a business user to interact with the data using a single user interface 314 without limitation on how that data was originally stored. The user interface 314 also enables a user to manipulate how data is linked, which is summarily stored in the virtual relations table.

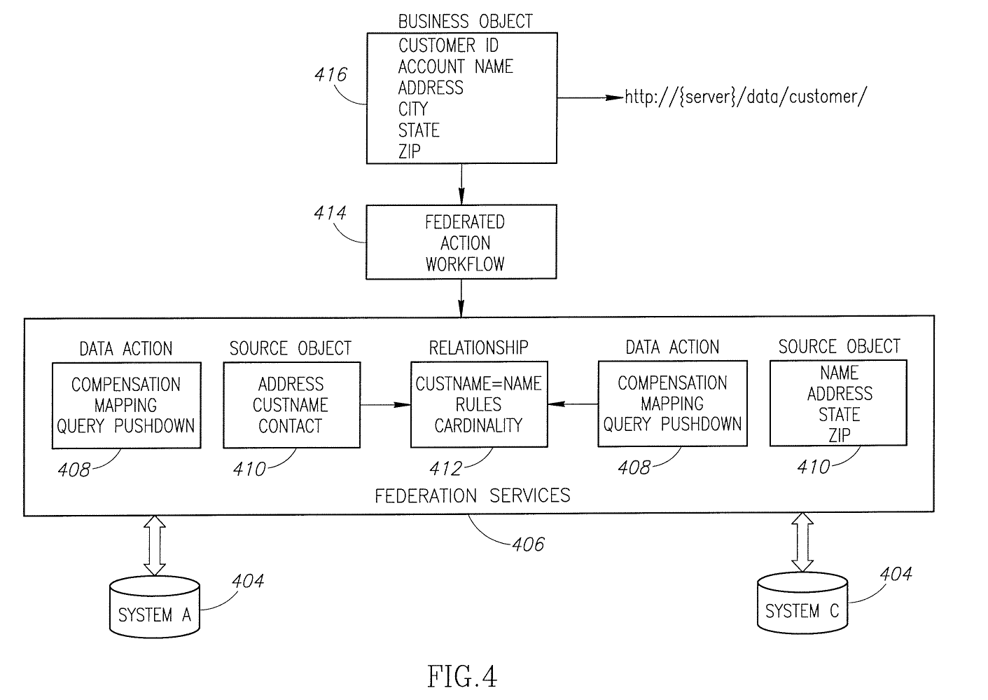

FIG. 4 shows a data federation overview. Federation Services 406 is in communication with multiple data sources 404. The multiple data sources 404 containing business information. The federation services 406 functions to capture data from each of the systems 304 and abstracts the data to determine the source object, data actions and a relationship between multiple data records. As shown in this example, a first source object 410 has a field CustName where the second source object 410 has a field name. The federation services 406 using data actions 408 works to map those two fields and therefore linking the source objects 410. All actions on the data in terms of virtual federation rules to apply, the mapping of information and the decoding of mapping so the appropriate data backend data sources are updated is handled in the Federated Action Workflow 414 A business object 416 gathers the federated data in order to be accessed by a user interface.

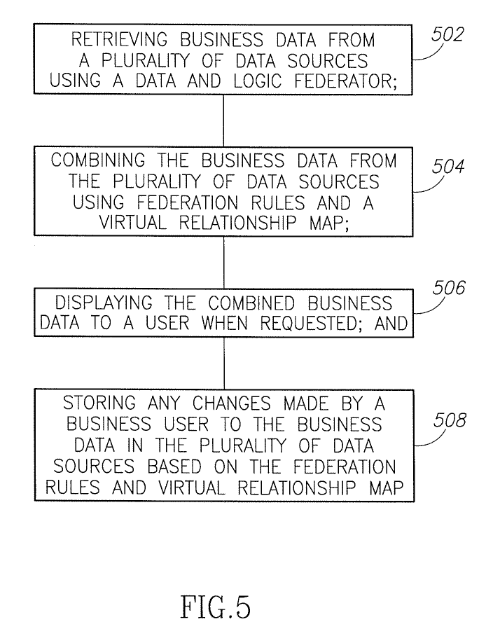

FIG. 5 shows a method of data federation in one embodiment. At block 610, business data is retrieved from a plurality of data sources using an information federator. The information federator gathers the data and logic from the data source. At block 620 business data is combined using federation rules and a virtual relationship map across multiple data sources. The combined business data is accessible through a business object and displayable to a user on a user interface. At block 630, the combined business data is displayed to a user when requested. The user may manipulate, delete, add or link the data. A user may link the data by linking two or more related or unrelated data records. At block 640, using the federation rules and the logic stored by the data federator, the change made by the user is stored in the applicable data sources. The change is entered in each data source using the logic necessary and the change to the data is stored in the system for future use.

The current invention advantageously allows for user driven federation, more particularly the fact that the business user controls and drives the federation. The field, record, list is defined by the user using virtual relationships of data. The data can be advantageously enriched. Further data cleanup rules can be presented to users and users can then maintain the data during usage. In one embodiment, the system has the ability to capture a mental mosaic of relationships that a user creates mentally while they are working. The system advantageously allows for collaborative building by users, becomes more relevant with usage, changes are made in real time and available for on the fly during usage. The changes are non-intrusive with the back end data sources. The system preferably captures a virtual data relationship of enterprise information. Finally, the system becomes more capable of self learning with usage.

These and other changes can be made in light of the above detailed description. In general, in the following claims, the terms used should not be construed to limit the invention to the specific embodiments disclosed in the specification and the claims, but should be construed to include all types of systems and methods for building and developing software applications that operate in accordance with the claims.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined by reference to the claims that follow.

The embodiments of the invention in which an exclusive property or privilege is claimed are defined as follows:

1. A system for data federation comprising:
a plurality of data sources;
a information federator configured to extract data and logic from the plurality of data sources;
a virtual data relationship map in data communication with the information federator such that when data is accessed in the plurality of data sources, the data can be linked across the multiple data sources;
a display having a user interface configured to allow a user to control an abstracted set of data and their relationships in real time; and
a processor configured to communicate any changes of the data to the information federator such that the underlying data is manipulated in the plurality of data sources based on the stored logic.

2. The system of claim 1, further comprising a business object configured to compile related data from the virtual data relationship map and communicate the data to the user interface.

3. The system of claim 1, wherein the plurality of data sources are in a plurality of data formats.

4. The system of claim 1, wherein the information federator contains at least one source object.

5. The system of claim 1, wherein the virtual relationship maps has at least one of a field, a record and a list that is defined by a user using the user interface.

6. The system of claim 1, wherein the user interface is configured to allow a user to enrich data in addition to the data in the plurality of enterprise data sources.

7. The system of claim 1, wherein the user interface is configured to allow a user to capture virtual data relationships between a plurality of records in the data sources when the data was not previously linked.

8. A method for data federation comprising:
retrieving business data from a plurality of data sources using a information federator;
combining the business data from the plurality of data sources using federation rules and a virtual relationship map;
displaying the combined business data to a user when requested; and
storing any changes made by a business user to the business data in the plurality of data sources based on the federation rules and a virtual relationship map.

9. The method of claim 8, further comprising capturing data relationships between a plurality of data records in a plurality of data sources.

10. The method of claim 8, further comprising capturing business logic in a plurality of data sources.

11. The method of claim 8, further comprising building a virtual relational data map of all of the data existing in the plurality of disparate systems using the captured data relationships;

12. The method of claim 8, further comprising capturing data relationships as they are constructed by a business user.

13. The method of claim 8, further comprising establishing a link between unrelated pieces of data from the plurality of data sources.

14. A method for data federation comprising:
capturing data relationships in a plurality of disparate systems;
building a virtual relational data map of a plurality of data fields and records existing in the plurality of disparate systems using the captured data relationships;
displaying through a user interface a relational database of enterprise data including all of the data from the plurality of disparate systems;
modifying a link between data fields and records in the plurality of disparate systems through a user interface; such that the relationships can be constructed and modified by users as they are working with the system in real time; and
updating the virtual relationship map to include the modified link, such that the link is now stored in the virtual relationship map for future use by the system.

15. The method of claim 13, retrieving business data from a plurality of data sources.

16. The method of claim 8, further comprising capturing business logic in a plurality of data sources.

17. The method of claim 13, further comprising manipulating a data record using the user interface.

18. The method of claim 13, further comprising storing any changes made by a business user to the business data during usage in the plurality of data sources based on the federation rules and a virtual relationship map.

19. The method of claim 18, wherein the changes made by a business user are at least one of changes to data and changes to data relationships.
